(19) United States
(12) Patent Application Publication
(10) Pub. No.: US 2026/0098823 A1
(43) Pub. Date: Apr. 9, 2026

(54) METHOD OF SAMPLE PREPARATION

(71) Applicant: FEI Company, Hillsboro, OR (US)

(72) Inventor: Chengge Jiao, Eindhoven (NL)

(21) Appl. No.: 19/352,851

(22) Filed: Oct. 8, 2025

Related U.S. Application Data
(60) Provisional application No. 63/704,995, filed on Oct. 8, 2024.

(51) Int. Cl. G01N 23/2005; G01N 1/28

(52) U.S. Cl. CPC G01N 23/2005; G01N 1/286

(57) ABSTRACT

Techniques for preparing a powder sample for charged particle beam microanalysis are described. A method for preparing a powder sample includes providing a silicon section configured with an uneven edge. The method includes positioning the silicon section on aluminum foil with the uneven edge adjacent to the foil. The method includes placing a powder sample on the foil. The method includes sliding or pushing the silicon section across the powder sample so that the uneven edge contacts and entrains the powder. The method also includes covering the entrapped powder with a sealant such as silver paint or carbon paint to encapsulate the particles.

### CROSS REFERENCE TO RELATED APPLICATION

The present application claims priority to the earlier-filed United States Provisional Patent Application number US63/704,995, entitled, “METHOD OF SAMPLE PREPARATION” and filed on October 8, 2024, the contents of which are hereby incorporated by reference, in their entirety.

### TECHNICAL FIELD

Embodiments of the present disclosure are directed to the field of sample analysis, such as morphology and microanalysis, and in particular, to a method of preparing powder sample cross sections for analysis by a charged particle microscope.

### BACKGROUND

The development of electron and scanning probe microscopies in the second half of the twentieth century has produced spectacular images of the internal structure and composition of matter with nanometer, molecular, and atomic resolution. Largely, this progress was enabled by computer-assisted methods of microscope operation, data acquisition, and analysis. Advances in imaging technology in the beginning of the twenty-first century have opened the proverbial floodgates on the availability of high-veracity information on structure and functionality. From the hardware perspective, high-resolution imaging methods now routinely resolve atomic positions with sub-Angstrom precision, allowing insight in the atomic structure and dynamics of materials.

Various kinds of microscopy can be relevant for the present disclosure, such as electron microscopy, charged-particle microscopy, Transmission Electron Microscope (TEM), Scanning Electron Microscope (SEM), and Scanning Transmission Electron Microscope (STEM), and also various sub-species, such as so-called “dual-beam” tools (e.g. a FIB-SEM), which additionally employ a Focused Ion Beam (FIB), allowing supportive activities such as ion-beam milling or Ion-Beam-Induced Deposition (IBID) or ion based imaging. This is a non-exclusive list of high-performance microscopy approaches.

As an alternative to the use of electrons as irradiating beam, charged-particle microscopy can also be performed using other species of charged particles. In this respect, the phrase “charged particle” should be broadly interpreted as encompassing electrons, positive ions (e.g. Ga or He ions), negative ions, protons and positrons, for instance.

As regards ion-based microscopy, some further information can, for example, be gleaned from sources such as the following: W. H. Escovitz, T. R. Fox and R. Levi-Setti, Scanning Transmission Ion Microscope with a Field Ion Source, Proc. Nat. Acad. Sci. USA 72(5), pp 1826-1828 (1975).

The listing or discussion of an apparently prior-published document in this specification should not necessarily be taken as an acknowledgement that the document is part of the state of the art or is common general knowledge.

It should be noted that, in addition to imaging, a charged-particle microscope (CPM) may also have other functionalities, such as performing spectroscopy, examining diffractograms, performing (localized) surface modification (e.g. milling, etching, deposition), etc.

A further approach in microscopy relates to the site-specific analysis, deposition, and ablation of materials by a focused ion beam, also known as FIB. This is a technique used particularly in the semiconductor industry, materials science and increasingly in the biological field. A FIB setup is a scientific instrument that resembles a scanning electron microscope (SEM). However, while the SEM uses a focused beam of electrons to image the sample in the chamber, a FIB setup uses a focused beam of ions instead. FIB can also be incorporated in a system with both electron and ion beam columns, allowing the same feature to be investigated using either of the beams.

Most widespread instruments useliquid metal ion sources (LMIS), for example gallium ion sources. In a gallium LMIS, gallium metal is placed in contact with a tungsten needle, and heated gallium wets the tungsten and flows to the tip of the needle, where the opposing forces of surface tension and electric field form the gallium into a cusp shaped tip called a Taylor cone. The huge electric field at this small tip (greater than 1×108 volts per centimetre) causes ionization and field emission of the gallium atoms.

Source ions are then generally accelerated to an energy of 1-50 keV (kilo-electronvolts) and focused onto the sample by electrostatic lenses. LMIS produce high current density ion beams with very small energy spread. A modern FIB can deliver tens of nano-amperes of current to a sample or can image the sample with a spot size on the order of a few nanometres.

Focused ion beam (FIB) systems have been produced commercially for approximately twenty years, primarily for large semiconductor manufacturers. FIB systems operate in a similar fashion to a scanning electron microscope (SEM) except, rather than a beam of electrons and as the name implies, FIB systems use a finely focused beam of ions (usually gallium) that can be operated at low beam currents for imaging or at high beam currents for site specific sputtering or milling.

High-current plasma FIB systems are now indispensable in both the semiconductor industry and in materials research for improving material removal rates and the final surface quality of cross sections or 3D tomography samples.

However, plasma FIB milling can also produce artifacts, such as curtains. The presence of such artifacts can make it more difficult to identify a defect or other features. The invention as defined herein, addresses at least some of these issues during the analysis of powder samples.

### SUMMARY

In an aspect, a method includes preparing a powder sample for analysis. The method can include providing a silicon section configured with an uneven edge, positioning the silicon section on aluminum foil with the uneven edge adjacent to the foil, and placing a powder sample on the foil. The method can further include sliding or pushing the silicon section across the powder sample so that the uneven edge contacts and entrains the powder, and then covering the entrapped powder with a sealant such as silver paint or carbon paint to encapsulate the particles.

In some embodiments, the powder sample can include anode or cathode particles. The method can further include milling the encapsulated particles to provide a cross-section, which can be carried out using a focused ion beam at beam currents from about 200 nA to about 1000 nA. The process can be performed under controlled atmospheric conditions, and encapsulation can employ silver paint or carbon paint.

In an aspect, a silicon section can include a powder sample encapsulated by a sealant. In some embodiments, the powder can be contained within the uneven edge of the silicon section. The sealant can include silver paint and/or carbon paint. A silicon product can also be obtained by the preparation process described herein.

In an aspect, a method of analysis can include providing a charged particle beam, preparing a powder sample within the uneven edge of a silicon section according to the described preparation process, directing the beam at the silicon section, and detecting particles emitted from the section. In some embodiments, the silicon section can be a milled cross-section produced using beam currents from about 200 nA to about 1000 nA. The uneven edge of the silicon section can act as a beam tail blocker during the analysis.

In an aspect, a charged particle beam system can include a focused ion beam source having an ion source and a focused ion beam column, and an electron beam source having an electron source and an electron optical column. The system can further include a vacuum chamber with a sample stage and detectors configured to generate data based on interactions of the beams with a sample, and control circuitry operably coupled to the beam sources and the sample stage. The system can also include one or more non-transitory media storing instructions that, when executed, cause the control circuitry to provide a charged particle beam, position a powder sample within an uneven edge of a silicon section, direct the beam at the silicon section, and detect particles emitted from the section.

In some embodiments, the system can be configured to mill the silicon section to expose a cross-section including the powder sample, using a focused ion beam at beam currents from about 200 nA to about 1000 nA. The uneven edge can act as a beam tail blocker during such milling. The powder sample can include anode and/or cathode particles, which can be at least partially encapsulated by silver paint or carbon paint.

The terms and expressions which have been employed are used as terms of description and not of limitation, and there is no intention in the use of such terms and expressions of excluding any equivalents of the features shown and described or portions thereof, but it is recognized that various modifications are possible within the scope of the claimed subject matter. Thus, it should be understood that although the present claimed subject matter has been specifically disclosed by embodiments and optional features, modification and variation of the concepts herein disclosed can be resorted to by those skilled in the art, and that such modifications and variations are considered to be within the scope of this disclosure as defined by the appended claims. For example, the preceding aspects and various embodiments can be combined with one or more other aspects and/or embodiments of the same or other aspects.

### BRIEF DESCRIPTION OF THE SEVERAL VIEWS OF THE DRAWINGS

The foregoing aspects and many of the attendant advantages of the present disclosure will become more readily appreciated as the same become better understood by reference to the following detailed description, when taken in conjunction with the accompanying drawings.

FIG. 1 is a schematic diagram illustrating an example silicon section positioned on aluminum foil indicating the direction of travel with relation to the powder sample and sealant.

FIG. 2 is a schematic diagram illustrating a silicon section including a powder sample encapsulated by a sealant.

FIG. 3 illustrates an example process for preparing and analyzing a powder sample.

FIG. 4 is a schematic diagram illustrating an example dual-beam system, in accordance with some embodiments of the present disclosure.

In the drawings, like reference numerals refer to like parts throughout the various views unless otherwise specified. Not all instances of an element are necessarily labeled to reduce clutter in the drawings where appropriate. The drawings are not necessarily to scale, emphasis instead being placed upon illustrating the principles being described.

### DETAILED DESCRIPTION

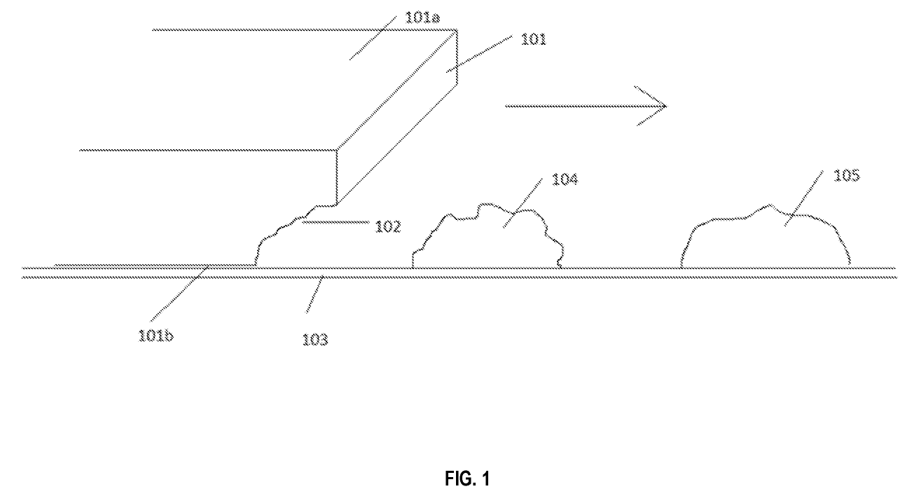

While illustrative embodiments have been illustrated and described, it will be appreciated that various changes can be made therein without departing from the spirit and scope of the disclosure. In the forthcoming paragraphs, embodiments of an analytical instrument system, components, and methods for in situ preparation of samples in a dual-beam FIB-SEM system. Embodiments of the present disclosure focus on preparing powder samples in plasma FIB (PFIB) instruments in the interest of simplicity of description. To that end, embodiments are not limited to such instruments, but rather are contemplated for analytical instrument systems that are configured for microscopy and microanalysis. Similarly, while embodiments of the present disclosure focus on electrospray PFIB-based methods for in situ sample prep of power samples, additional and/or alternative sample types are contemplated, including but not limited to samples capable of conforming to a negative space in a host section (e.g., silicon section 101 of FIG. 1).

Focused ion beam (FIB) plasma cross-section preparation traditionally requires a series of sequential steps, including gas injection system (GIS) deposition and rocking milling. While widely adopted, these procedures add complexity, extend processing time, and frequently introduce artifacts such as milling curtains. Methods of the present disclosure provide a simplified alternative that eliminates these requirements while also improving the quality of sections in multiple sample types, including with powder samples.

In conventional plasma FIB preparation, a protective cap layer of platinum or carbon is deposited at low accelerating voltages using a gas injection system, or GIS. Subsequent milling is initiated at high current, typically with the same ion source. To suppress milling curtains, the specimen stage is then rocked during processing, with the beam current gradually reduced to approximately 60 nA or less in order to generate larger cross-sections with acceptable quality.

In contrast to the conventional techniques, methods of the present disclosure begin with preparation of a powder sample according to the defined procedure. GIS deposition is unnecessary, as the silicon-cleaved edge itself serves as an effective protective barrier, thereby removing the need for an additional cap layer. Similarly, rocking milling is not required. The single-crystal nature of the cleaved silicon inherently suppresses beam tails, allowing for stable high-current milling without the formation of curtains. This enables the application of substantially higher final milling currents—up to 200 nA and beyond—without compromising section integrity.

The advantages of this approach are multifold. The process is streamlined, reducing procedural complexity and overall preparation time. Efficiency is enhanced through the elimination of both GIS deposition and rocking milling. Moreover, the resulting cross-sections exhibit superior quality, remaining free of curtains and avoiding the structural artifacts commonly introduced by protective cap layers.

The integration of silicon cleaving with a modified plasma FIB cross-section preparation strategy offers a significant advancement over established methodologies. This approach is particularly advantageous for beam-sensitive and ultra-hard materials, which are often difficult to process using conventional techniques. By obviating the need for auxiliary deposition and stage rocking, the method reduces specimen damage and distortion, yielding higher-quality cross-sections suitable for demanding analytical applications.

FIG. 1 illustrates the positioning and direction of travel of the silicon section (101) on the aluminum foil (103) in relation to the uneven edge (102), the powder sample (104), and the sealant (105) in one embodiment.

As described herein, a silicon section (101) having an uneven edge (102) is provided. The silicon section (101) is typically substantially cuboid in shape, comprising an upper surface (101a), a lower surface (101b), and four side surfaces perpendicular to the upper and lower surfaces, although alternative shapes and geometries can also be employed to achieve equivalent effects.

The term “uneven surface,” when used in relation to the silicon section, refers to an arrangement in which the upper surface (101a) of the silicon section (101) extends beyond the lower surface (101b) in a longitudinal direction. In other words, the upper surface (101a) overhangs the lower surface (101b).

The upper surface (101a) can extend beyond the lower surface (101b) by any distance suitable to accommodate the powder sample (104). Representative distances include approximately 10 µm to 1000 µm, for example, 50 µm to 500 µm, or 100 µm to 250 µm. Where the upper surface (101a) extends beyond the lower surface (101b), the thickness of the upper surface (101a) can range from approximately 5 µm to 100 µm, for example, 10 µm to 50 µm, or 20 µm to 30 µm. The thickness of the upper surface (101a) can remain constant or vary across its span. For instance, the thickness at the point where the lower surface (101b) terminates can be greater or smaller than the thickness at the distal portion of the upper surface (101a).

The uneven edge (102) of the silicon section (101) can be formed by any suitable technique. A common procedure involves cleaving the silicon using a diamond scriber, followed by physically breaking the scribed section, for example by applying mechanical force. Accordingly, the method can include a preliminary step of cleaving the silicon to generate the uneven edge (102).

The upper surface (101a) of the silicon section (101) is typically polished and substantially free of dust or particulate contamination, whereas the lower surface (101b) is typically unpolished. The uneven edge (102) can comprise microcavities capable of receiving and holding powder particles.

The silicon section (101) with the uneven edge (102) is placed on aluminum foil (103), such as a sheet of aluminum foil, with the upper surface (101a) oriented upward. A powder sample (104) is also positioned on the aluminum foil (103). The powder sample (104) can be positioned on the aluminum foil either before or after placement of the silicon section (101). In either arrangement, the uneven edge (102) of the silicon section (101) is positioned adjacent to the powder sample (104).

The powder sample (104) can include any material suitable for analysis by a charged particle microscope. Examples include ceramic powders used in all-solid-state batteries; graphite, hard graphite, and Si/SiO₂/graphite mixtures for lithium-ion battery anodes; LFP, NMC, and LMN powders for lithium-ion battery cathodes; and hard material powders such as BN, SiC, Al₂O₃, diamond, and WC.

Placement of the powder sample (104) onto the aluminum foil (103) can be achieved by any suitable means, for example by applying the powder manually with a spatula, via automated dispensing, or by tapping to achieve even distribution.

The silicon section (101) is then moved such that the uneven edge (102) passes over or through the powder sample (104). Movement can be accomplished by pushing or sliding the silicon section (101) across the aluminum foil (103), manually using tweezers or gloved fingers, or by automated systems such as robotic arms or robotic tweezers. In cases where the powder sample (104) is sensitive to environmental factors such as air or moisture, movement can be carried out in a glove box or controlled atmosphere chamber.

As the uneven edge (102) passes through the powder sample (104), a portion of the powder becomes collected within the recess created by the overhanging upper surface (101a) relative to the lower surface (101b). Once the silicon section (101) has been moved across the powder sample (104), the collected powder is encapsulated by a sealant (105), such as silver paint or carbon paint, which secures the powder within the uneven edge (102).

Application of the sealant (105) can be performed by any appropriate method. In certain embodiments, the sealant (105) is positioned adjacent to the powder sample (104) on the aluminum foil (103). In this arrangement, as the silicon section (101) traverses the powder sample (104), the collected powder subsequently contacts the sealant (105), becoming encapsulated. This process is depicted in FIG. 1. It is preferable that the sealant (105) covers only the powder sample (104) contained within the uneven edge (102) and does not extend over the polished upper surface (101a).

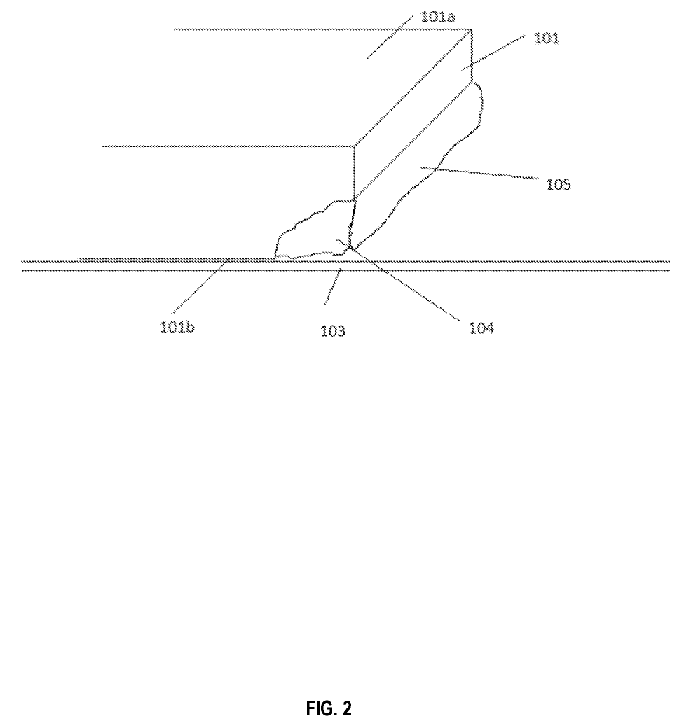

The resulting silicon section (101), containing the powder sample (104) encapsulated by the sealant (105) as illustrated in FIG. 2, can then undergo further preparation, such as cross-sectioning, subsequent analysis, or storage until required.

The powder sample (104) is generally a material intended for analysis by a charged particle microscope, particularly a focused ion beam (FIB) or plasma FIB instrument for cross-sectional morphology studies, including scanning electron microscopy with energy-dispersive X-ray spectroscopy (SEM-EDS) and focused ion beam secondary ion mass spectrometry (FIB-SIMS).

Encapsulation of the powder sample (104) within the uneven edge (102) of the silicon section (101) allows the upper surface (101a) of the silicon section to function as a beam-tail blocker during further milling. This configuration reduces or prevents the formation of milling curtains and related artifacts during ion beam processing.

The method can further include milling the silicon section (101) to provide a cross-section, which can then be subjected to analysis. Due to the presence of the overhanging upper surface (101a), milling can be conducted at higher beam currents than typically feasible. Suitable beam currents include values greater than 200 nA, for example from approximately 200 nA to 1000 nA, or from 400 nA to 800 nA. Because the beam tails initially impact the upper surface (101a), the powder sample (104) is shielded from direct exposure, significantly reducing the occurrence of milling curtains.

Throughout the process, it is preferable that the upper surface (101a) of the silicon section (101) remains substantially free of particulate contamination that could contribute to milling artifacts. Cleaning steps can therefore be incorporated between stages of the method, utilizing techniques such as optical inspection or air dusting to maintain a particle-free surface.

Finally, the method can include analyzing the resulting cross-section using a charged particle microscope.

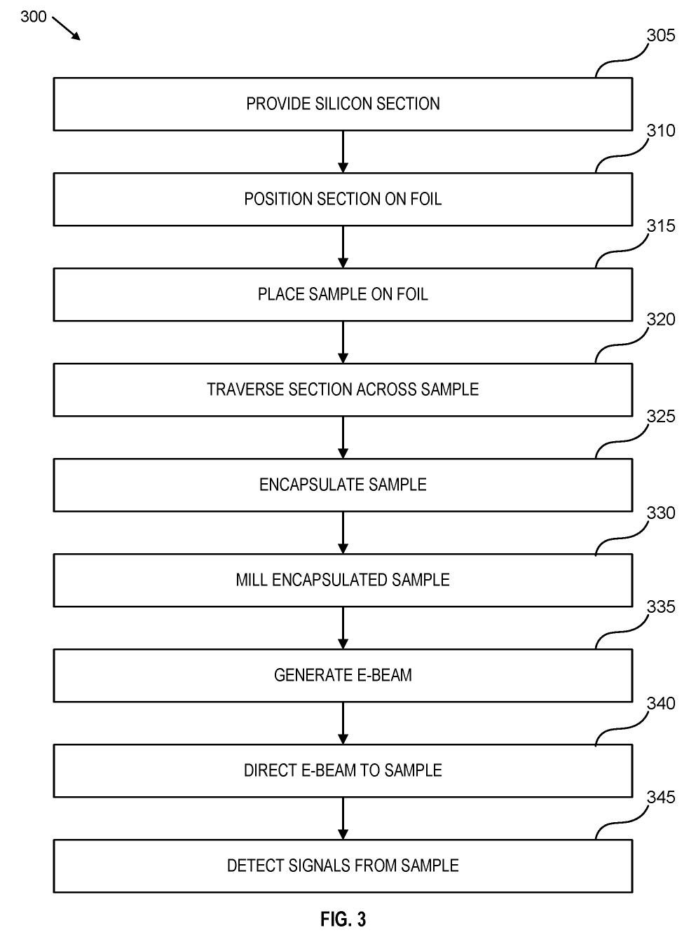

FIG. 3 illustrates an example process 300 for preparing and analyzing a powder sample. The process may be performed manually or by automated handling systems, and in preferred embodiments, portions of the process are carried out within or in conjunction with a dual-beam focused ion beam–scanning electron microscope (FIB-SEM) system. It should be understood that while the operations of process 300 are described in a sequential manner for clarity, the order may be altered, combined, or supplemented without departing from the scope of the present disclosure. Operations of the example process 300 can be omitted, repeated, reordered, or replaced, in some embodiments.

In operation 305, a section of silicon is provided. As depicted in FIG. 1, the silicon section 101 is prepared so that one side defines an uneven edge 102 formed by an overhanging upper surface 101a extending beyond the lower surface 101b. This overhang, which may range from approximately 10 µm to 1000 µm depending on the intended particle size, forms a recess that can receive powder particles. The uneven edge may be generated by cleaving the silicon with a diamond scriber, resulting in microcavities suitable for entrapping particles.

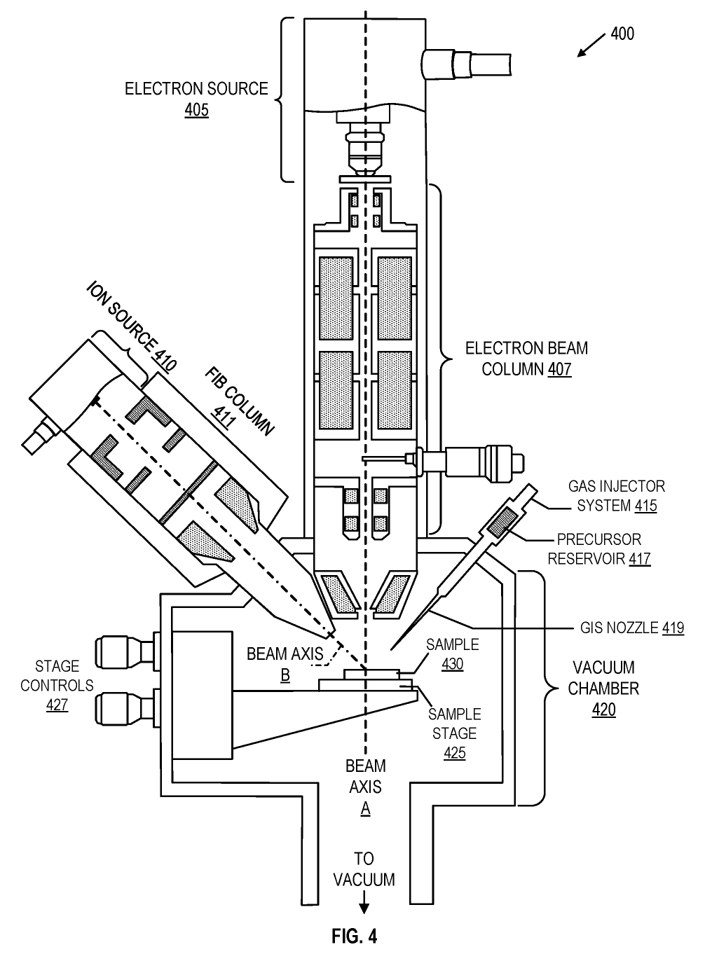

In operation 310, the silicon section 101 is positioned on aluminum foil 103 with the uneven edge 102 oriented adjacent to the foil, thereby creating a boundary region for capturing particles. The aluminum foil serves not only as a substrate but also as a conductive backing to ensure that the sample is electrically grounded once transferred into the chamber of a charged particle instrument such as the dual-beam system of FIG. 4.

In operation 315, a powder sample 104 is placed on the aluminum foil 103, as further illustrated in FIG. 1. The powder may include cathode or anode particles (such as LFP, NMC, LMN, or Si/graphite mixtures) or hard material powders (BN, SiC, Al₂O₃, diamond, WC), all of which are candidates for charged particle microscopy. Placement can be achieved using a spatula, an automated dispenser, or controlled tapping to distribute the particles evenly across the foil.

In operation 320, the silicon section 101 is slid or pushed across the aluminium foil 103 so that the uneven edge 102 traverses the powder sample 104. As described with reference to FIG. 1, this sliding action entraps a portion of the powder within the recess formed by the overhanging upper surface 101a. Movement may be accomplished by hand (using tweezers or gloved fingers) or by robotic manipulation within a glove box or controlled atmosphere to avoid moisture or oxygen exposure for sensitive powders. As the edge passes through the powder, particles become lodged within the uneven recess, which is specifically designed to confine and stabilize the particles.

In operation 325, the entrapped powder is encapsulated with a sealant 105 such as silver paint or carbon paint, also shown in FIG. 1. Encapsulation fixes the particles in place and provides an electrically conductive pathway that suppresses charging under electron or ion beam exposure. In some embodiments, the sealant is pre-applied to a location adjacent to the powder so that the traversing silicon edge picks up and encapsulates particles in a single motion. The result is the prepared sample shown in FIG. 2: a silicon section 101 containing powder 104 secured within the uneven edge 102 and immobilized by the sealant 105.

In operation 330, the encapsulated powder can be milled to provide a cross-section. This step is performed within a dual-beam FIB-SEM, such as the system 400 of FIG. 4, which combines an ion column 411 and an electron column 407 converging on the sample 430. The sample stage 425 is adjusted to orient the encapsulated region at a tilt angle favorable for ion beam incidence. A focused ion beam generated by ion source 410 is directed to remove material from the encapsulated region at beam currents ranging from about 200 nA to about 1000 nA. The overhanging upper surface 101a of the silicon section serves as a beam-tail blocker, absorbing peripheral ions and reducing the formation of milling curtains. The milling exposes a clean cross-section of the powder particles, which can then be imaged in situ using the SEM column 407. Because the FIB and SEM columns are convergent, the electron beam can be used simultaneously to image the progress of milling and to capture high-resolution images of the freshly exposed surfaces.

Following sample preparation, the process optionally continues with charged particle analysis. In analysis operation 335, the SEM column 407 provides a beam of electrons to interrogate the milled cross-section or, in some cases, the as-encapsulated edge region. In analysis operation 340, this beam is directed onto the sample, with the stage 425 and electromagnetic optics of the column adjusting magnification, scan patterns, and dwell times. The electron beam may also be used in coordination with the gas injection system (GIS) 415 for local deposition or protection of surfaces prior to analysis. In analysis operation 345, signals emitted from the sample are detected by SEM detectors or ion-induced secondary electron detectors, enabling imaging, compositional mapping, and spectroscopy. For example, SEM imaging can be combined with energy-dispersive X-ray spectroscopy (EDS) for elemental mapping, or with FIB-SIMS for isotopic or chemical analysis.

Throughout the process, environmental and operational conditions may be controlled to preserve powder integrity. For example, the powder can be encapsulated in a glove box under inert atmosphere and the FIB-SEM chamber can be operated at low contamination background. The automation subsystems of the dual-beam system 400 can coordinate ion milling, electron imaging, stage tilting, and detector collection to implement process 300 reproducibly.

Through these operations, process 300 achieves a reproducible workflow for preparing and analyzing powder samples. As illustrated by FIGS. 1 and 2, the uneven edge of the silicon section provides a physical mechanism for entrapping and encapsulating powders, while the dual-beam FIB-SEM system of FIG. 4 provides both the means to expose clean cross-sections and the instrumentation for high-resolution imaging and compositional analysis. In this way, the process combines mechanical entrapment, encapsulation, and charged particle processing into an integrated methodology suitable for advanced material studies.

FIG. 4 is a schematic diagram illustrating an example dual-beam system 400, in accordance with some embodiments of the present disclosure. The example system 400 includes an electron source 405, an electron beam column 407, an ion source 410, a focused ion beam ("FIB") column 411, a gas injection system ("GIS") 415, a vacuum chamber 420, and a sample stage 425. The electron beam column 407 is illustrated as a scanning electron microscope (SEM) column, such that the example system 400 corresponds to a dual beam FIB-SEM system. The electron beam column 407, the FIB column 411, and the GIS 415 are illustrated as being operably coupled with the vacuum chamber 420, with the electron beam column 407 defining a first beam axis A and the FIB column 411 defining a second beam axis B. The axes A and B are illustrated converging onto a region of a sample 430, with the GIS 415 oriented toward the region of the sample 130 and configured to direct a gas stream including a precursor into the vacuum chamber. Advantageously, while axes A and B can also be oriented toward different locations, convergence permits the SEM system to image the region of the sample being processed by the FIB.

The electron source 405 can include one or more emitters configured to generate free electrons and to direct the electrons into the electron beam column 407. The emitters can include thermionic emitters, Schottky emitters, field-emission source emitters, or combinations thereof, operably coupled to power systems configured to apply a high-voltage (e.g., on the order of kilovolts to hundreds of kilovolts) to an emission region of the emitter material. For example, the electron source 405 can include a lanthanum hexaboride (LaB₆) emitter crystal to which a high electrical potential is applied to elicit the emission of electrons from a tip of the emitter crystal. In this way, a beam of electrons can be directed into the electron beam column 407.

The electron beam column 407 includes electromagnetic optics (e.g., electrostatic lenses, electromagnetic lenses, monochromators, aberration correctors, etc.) and apertures configured to shape, focus, defocus, narrow, and/or direct the beam of electrons such that the beam is focused onto the sample 430, in accordance with a set of operating parameters. The operating parameters can include a beam current, a beam energy (e.g., in volts, in electron volts, or the like), a magnification parameter, a scan pattern, a dwell time, and/or one or more pulse parameters. In this way, the example system 400 can function as an SEM to image portions of the sample 430 and/or can be used for e-beam assisted deposition of material onto the sample 430 (e.g., in coordination with the GIS 415) or other sample modifications.

The ion source 410 can include one or more components configured to generate a beam of ions and to direct the ions into the FIB column 411. In general, the ions can include metal ions and/or nonmetal ions (e.g., noble gas, halogen, oxygen, nitrogen, or the like). To that end, the ion source 410 can include a plasma source (e.g., an inductively coupled plasma source or a microplasma source of the present disclosure) and/or a metal ion source (e.g., a liquid-metal ion source). In the context of the present disclosure, atomic and/or molecular gases and their mixtures can serve as plasma precursor gases, from which a stream of ions can be extracted.

As with the electron beam column 407, the FIB column 411 can include electromagnetic optics (e.g., electrostatic lenses, electromagnetic lenses, monochromators, etc.) and apertures configured to shape, focus, defocus, narrow, and/or direct the beam of ions such that the beam is focused onto the sample 430, in accordance with a set of operating parameters. The operating parameters can include a beam current, a beam energy (e.g., in volts, in electron volts, or the like), a magnification parameter, a scan pattern, a dwell time, and/or one or more pulse parameters. In this way, the example system 400 can function as a FIB to modify portions of the sample 130 and/or to be used for ion-beam assisted removal of material from and/or deposition of material onto the sample 430 (e.g., in coordination with the GIS 415).

Analogous to the energies described in reference to the electron beam, above, the ion beam energy can be selected (e.g., by a user, by an algorithm initiated by a user, and/or automatically without user intervention). In some embodiments, additional and/or alternative precursor decomposition mechanisms (e.g., surface activation and/or secondary electron reemission) can be used as a mechanism for precursor decomposition, thereby allowing the ion beam energy to be determined based at least in part on a relationship between beam energy, sample material properties, and the energetic characteristics of the precursor deposition reaction mechanism. Advantageously, ion beam-induced deposition can elicit relatively high yields, in comparison to electron beam-induced deposition, based at least in part on the combined effect of multiple energy transfer pathways.

The GIS 415 includes constituent elements that together permit the GIS 415 to generate a gas stream including the precursor and to direct the gas stream into the vacuum chamber. The components of the GIS 415 can include a carrier gas inlet, a nozzle 419, and a conduit fluidically coupling the nozzle 419 and a precursor reservoir 417. The precursor reservoir 417 can include a substantially non-reactive container (e.g., a ceramic crucible, PTFE enclosure, a non-reactive metal or alloy, or the like) that is at least partially exposed to the conduit. In this way, vapor generated from a precursor disposed in the precursor reservoir 417 can be directed toward the nozzle and into the vacuum chamber (e.g., by pressure-driven flow induced by a pressure gradient relative to the vacuum of the vacuum chamber). In some embodiments, the GIS 415 includes a carrier gas inlet, fluidically coupled with the nozzle 419 via the conduit. In this way, the precursor can be entrained in a flow of carrier gas and directed toward the nozzle and into the vacuum chamber. Additionally and/or alternatively, the precursor can include a gas at standard conditions and can be introduced to the GIS 415 via a gas inlet provided as part of the GIS 415.

The operation of one or more components of the example system 400 can be coordinated by control circuitry, in accordance with machine-executable instructions (e.g., software, firmware, etc.) that can be stored in machine-readable storage media and/or received from external systems via wired and/or wireless communication techniques (e.g., over a WiFi or Bluetooth link). To that end, components of the example system 400 can be automated (e.g., operating without human intervention), pseudo-automated (e.g., operating with limited human intervention to initiate operations, analyze output and confirm, or the like), or manually operated (e.g., where individual operations of the example system 400 are performed and/or coordinated by a human user). In an illustrative example, the sample stage 425 can be mechanically coupled with automated stage controls 427 that permit the sample 430 to be reversibly tilted relative to the beam axes A and B, such that the surface of the sample is oriented at a particular angle relative to a given beam axis during operation of the corresponding charged particle beam source. In this way, the operation of a given beam source can be coordinated with the operation of the stage controls 427. In another example, detectors provided as part of the example system 400 can be integrated into a control system that is configured to manipulate one or more operating parameters of the ion source 410, as part of a control scheme to implement one or more of the processing techniques described in reference to FIGS. 1-3 of the present disclosure.

Some embodiments of the present disclosure omit one or more components of example system 400. For example, one or more of the sources 405 and 410 and/or columns 407 and 411 can be omitted. In an illustrative example, an single-beam FIB system can be configured to perform operations for generating a beam of ions. Similarly, a multi-beam FIB system other than a dual-beam FIB-SEM (e.g., a FIB-Laser system or a FIB-SEM system for which two or more beam axes are not convergently trained on a given region of the sample 430) can implement the the charged particle processing techniques of the present disclosure.

In the preceding description, various embodiments have been described. For purposes of explanation, specific configurations and details have been set forth in order to provide a thorough understanding of the embodiments. However, it will also be apparent to one skilled in the art that the embodiments may be practiced without the specific details. Furthermore, well-known features may have been omitted or simplified in order not to obscure the embodiment being described. While example embodiments described herein center on charged particle beam systems, and dual-beam FIB-SEM systems in particular, these are meant as non-limiting, illustrative embodiments. Embodiments of the present disclosure are not limited to such embodiments, but rather are intended to address analytical instruments systems for which a wide array of material samples can be analyzed to determine chemical, biological, physical, structural, or other properties, among other aspects, including but not limited to chemical structure, trace element composition, or the like.

Some embodiments of the present disclosure include a system including one or more data processors and/or logic circuits. In some embodiments, the system includes a non-transitory computer readable storage medium containing instructions which, when executed on the one or more data processors and/or logic circuits, cause the one or more data processors and/or logic circuits to perform part or all of one or more methods and/or part or all of one or more processes and workflows disclosed herein. Some embodiments of the present disclosure include a computer-program product tangibly embodied in non-transitory machine-readable storage media, including instructions configured to cause one or more data processors and/or logic circuits to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the claims. Thus, it should be understood that although the present disclosure includes specific embodiments and optional features, modification and variation of the concepts herein disclosed may be resorted to by those skilled in the art, and that such modifications and variations are considered to be within the scope of the appended claims.

Where terms are used without explicit definition, it is understood that the ordinary meaning of the word is intended, unless a term carries a special and/or specific meaning in the field of charged particle microscopy systems or other relevant fields. The terms “about” or “substantially” are used to indicate a deviation from the stated property within which the deviation has little to no influence of the corresponding function, property, or attribute of the structure being described. In an illustrated example, where a dimensional parameter is described as “substantially equal” to another dimensional parameter, the term “substantially” is intended to reflect that the two parameters being compared can be unequal within a tolerable limit, such as a fabrication tolerance or a confidence interval inherent to the operation of the system. Similarly, where a geometric parameter, such as an alignment or angular orientation, is described as “about” normal, “substantially” normal, or “substantially” parallel, the terms “about” or “substantially” are intended to reflect that the alignment or angular orientation can be different from the exact stated condition (e.g., not exactly normal) within a tolerable limit. For dimensional values, such as diameters, lengths, widths, or the like, the term “about” can be understood to describe a deviation from the stated value of up to ±10%. For example, a dimension of “about 10 mm" can describe a dimension from 9 mm to 11 mm.

The description provides exemplary embodiments, and is not intended to limit the scope, applicability or configuration of the disclosure. Rather, the ensuing description of the exemplary embodiments will provide those skilled in the art with an enabling description for implementing various embodiments. It is understood that various changes may be made in the function and arrangement of elements without departing from the spirit and scope as set forth in the appended claims. Specific details are given in the description to provide a thorough understanding of the embodiments. However, it will be understood that the embodiments may be practiced without these specific details. For example, specific system components, systems, processes, and other elements of the present disclosure may be shown in schematic diagram form or omitted from illustrations in order not to obscure the embodiments in unnecessary detail. In other instances, well-known circuits, processes, components, structures, and/or techniques may be shown without unnecessary detail.

What is claimed is:

1. A method of preparing a powder sample, the method comprising:
providing a section of silicon to provide an uneven edge;
positioning the silicon section on aluminium foil with the uneven edge positioned next to the aluminium foil;
placing a powder sample on the aluminium foil;
sliding/pushing the silicon section over the powder sample (particles) so that the uneven edge contacts/moves over/entraps the powder; and
covering the powder entrapped in the uneven edge with a sealant (i.e. silver paint or carbon paint) to encapsulate the particles.

2. The method according to claim 1, wherein the powder sample comprises anode and/or cathode particles.

3. The method of claim 1, further comprising milling the encapsulated particles to provide a cross-section.

4. The method of claim 3, wherein the milling is conducted at beam currents from about 200nA to about 1000nA.

5. The method of claim 1, wherein the method is conducted under controlled atmospheric conditions.

6. The method of claim 1, wherein the sealant comprises silver paint or carbon paint.

7. The method of claim 1, further comprising performing analysis of the powder sample in a charged particle beam system, the analysis comprising:
providing a charged particle beam;
providing the powder sample within the uneven edge of the silicon sample;
directing the beam at the silicon section; and
detecting particles emitted from the silicon section.

8. The method of claim 7, further comprising milling the silicon section to produce a milled cross-section.

9. The method of claim 8, wherein the silicon is milled at beam currents from about 200nA to about 1000nA.

10. The method of claim 7, wherein the uneven edge is a beam tail blocker.

11. A silicon section comprising a powder sample encapsulated by a sealant.

12. The silicon section of claim 11, wherein the powder sample is encapsulated in an uneven edge of the silicon section.

13. The silicon section of claim 12, wherein the powder sample at least partially fills the uneven edge, the powder sample being introduced into the uneven edge by a series of steps including:
providing the silicon section including the uneven edge;
positioning the silicon section on aluminum foil with the uneven edge positioned next to the aluminum foil;
placing the powder sample on the aluminum foil;
sliding/pushing the silicon section over the powder sample (particles) so that the uneven edge contacts/moves over/entraps the powder; and
covering the powder entrapped in the uneven edge with a sealant (i.e. silver paint or carbon paint) to encapsulate the particles.

14. The silicon section of claim 11, wherein the sealant is silver paint and/or carbon paint.

15. A charged particle beam system, comprising:
a focused ion beam (FIB) source, including an ion source and a FIB column;
an electron beam (e-beam) source, including an electron source and an electron optical column;
a vacuum chamber, including a sample stage and one or more detectors configured to generate data describing an interaction of a FIB or an e-beam with a sample disposed on the sample stage;
control circuitry, operably coupled with the FIB source, the e-beam source, and the sample stage; and
one or more non-transitory media storing machine-readable instructions that, when executed by a machine, cause the control circuitry to operate the components of the system to perform operations comprising:
providing a charged particle beam;
providing a powder sample within an uneven edge of a silicon sample as defined by the process of claim 1;
directing the beam at the silicon section; and
detecting particles emitted from the silicon section.

16. The system of claim 15, wherein the operations further comprise milling the silicon sample to expose a cross-section including the powder sample.

17. The system of claim 16, wherein the silicon sample is milled using a FIB, using a beam current from about 200nA to about 1000nA.

18. The system of claim 16, wherein the uneven edge is a beam tail blocker.

19. The system of claim 15, wherein the powder sample comprises anode and/or cathode particles.

20. The system of claim 19, wherein the powder sample is at least partially encapsulated in silver paint or carbon paint.
